(19) United States
(12) Patent Application Publication
(10) Pub. No.: US 2018/0123366 A1
(43) Pub. Date: May 3, 2018

(54) CONVENIENCE CHARGER AND COMBINATION

(71) Applicant: HCL DESIGNS, LLC, Hanover, MA (US)

(72) Inventors: Brian P. ANTONETTI, Hanover, MA (US); Robert E. TUFFY, Hanover, MA (US); Suzanne TUFFY-ANTONETTI, Hanover, MA (US); Justin AIELLO, Kennebunk, ME (US)

(21) Appl. No.: 15/859,485

(22) Filed: Dec. 30, 2017

Related U.S. Application Data
(63) Continuation-in-part of application No. PCT/US2016/040883, filed on Jul. 1, 2016.
Application No. PCT/US2016/040883 is a continuation-in-part of application No. 29/603,444, filed on May 9, 2017.
Application No. 29/603,444 is a continuation-in-part of application No. 29/604,372, filed on May 17, 2017.
Application No. 29/604,372 is a continuation-in-part of application No. 29/604,439, filed on May 17, 2017.
(60) Provisional application No. 62/187,389, filed on Jul. 1, 2015.
(60) Provisional application No. 62/262,722, filed on Dec. 3, 2015.
(60) Provisional application No. 62/277,892, filed on Jan. 12, 2016.
(60) Provisional application No. 62/343,084, filed on May 30, 2016.

(51) Int. Cl. H02J 7/00; H02J 7/02

(52) U.S. Cl. CPC H02J 7/0044; H02J 7/025; H02J 7/0047

(57) ABSTRACT

A charging system for a personal electronic device provides individual localized outlets along with convenience features for a domestic user or a patron of a hospitality facility.

### CROSS-REFERENCE TO RELATED APPLICATIONS

The present application is a continuation-in-part of PCT patent application PCT/US2016/040883 filed on Jul. 1, 2016, which claims the benefit of U.S. provisional patent application 62/187,389 filed on Jul. 1, 2015 and claims the benefit of U.S. provisional patent application 62/262,772 filed on Dec. 3, 2015, and claims the benefit of U.S. provisional patent application 62/277,892 filed on Jan. 12, 2016, and claims the benefit of U.S. provisional patent 62/343,084 filed on May 30, 2016; the present application is also a continuation-in-part of each of co-pending United States design patent applications numbered Ser. No. 29/603,444 filed May 9, 2017, Ser. No. 29/604,372 filed May 17, 2017, and Ser. No. 29/604,439 filed May 17, 2017. The disclosures of all of the foregoing are incorporated by reference in their entireties in the present application.

### FIELD OF THE INVENTION

The present invention relates to electronic systems, and more particularly to electronic device charging systems.

### SUMMARY

For the want of a nail the shoe was lost,

For the want of a shoe the horse was lost,

For the want of a horse the rider was lost,

For the want of a rider the battle was lost,

For the want of a battle the kingdom was lost,

And all for the want of a horseshoe-nail.

Benjamin Franklin and others.

Access to information, and personal availability for communication, are defining characteristics of our era. This access and availability are ubiquitous and continuous. Almost everyone is online all the time.

Much of the bandwidth involved in these communications is devoted to trivialities. Nevertheless, within the mass of inconsequential information there are individual items that, alone or in combination, have great consequence for our social and commercial relationships. We all understand that missing one item of information or failing to respond to a crucial inquiry from a client or social partner can have a disproportionate impact on our lives. Because of this, many of us have come to rely deeply on our personal electronic devices in ways that we perceive both consciously and intuitively. As a result, there is an urgent motivation to keep these devices functional.

The inventors of the present invention have, through personal experience, analysis, and the careful observation of human behavior, come to understand the depth and force of this motivation. They appreciate the degree to which wide swaths of society feel compelled to maintain and preserve the continuity and functionality of their information links, and the depth of the impulse to ensure that a personal communication device (such as a cell phone, smart phone, tablet, laptop computer, etc.) is charged and operational.

The inventors have observed that this impulse is particularly strong for those who are traveling on business, and those in problematic social situations, where the abundance of communication channels one might find in, e.g., an office setting, is reduced to one or two devices. In these situations, access to a crucial data point such as a delayed airplane departure, a breaking political news item, a sports outcome or a missed phone call from a client, a child, a spouse or other partner can have all the import for life success of the proverbial horseshoe nail.

At the same time, those who provide environments and accommodations to these mobile users face stiff competition for patrons and customers. They are strongly motivated to make their facilities attractive and functional, so as to entice what is often the most lucrative market segment into their businesses. They seek to develop a coherent aesthetic experience, an atmosphere, that is pleasant and inviting, and that provides every desirable resource and convenience without exposing their patrons to obtrusive reminders of the stressors that are constantly pending at the edge of consciousness.

The inventors, thus appreciating the importance of combining functionality with unobtrusive beauty, have arrived at certain new and useful inventions as further described herewith. Specifically, the inventors have come to appreciate that there is great utility to be found in a charging receptacle for a personal electronic device, where that charging receptacle is designed for discrete and aesthetically attractive placement in commercial and private establishments, localized adjacent to dining and working facilities. They have further come to understand and appreciate that combining such a charging receptacle with additional convenience features such as, for example, a coat hook, a pocketbook support, a personal device support, a luggage rack, and many other features, of which the foregoing are merely exemplary, can have great utility and benefit. They have observed that these important elements and combinations are novel. Moreover they have discovered that these inventions can have a commercial and functional significance that is surprisingly important and beneficial in ways just as unexpected and astonishing as the influence of the lost horseshoe nail.

As will be further described below, with reference to exemplary embodiments and aspects thereof, a device prepared according to the invention will include a localized electronic receptacle. In certain embodiments, this localized electronic receptacle will include a convenience feature. In certain examples, the electronic receptacle will be a USB receptacle of any known or anticipated size, and the convenience feature will be a pocketbook hook.

In one embodiment, the invention includes a system having a power supply and a plurality of charging modules. The charging modules are arranged to be more or less permanently mounted to a service location such as a bar, table, or service counter, and to be coupled to one another and to the power supply with electrical conductors. In a typical application, the power supply is engineered to receive mains power from a normal wall receptacle and convert that mains power to a regulated or unregulated voltage appropriate for charging a personal electronic device such as a cell phone, smart phone, tablet computer, laptop computer or other consumer article such as is known or may become known in the art. Power is distributed from the power supply to the charging modules over electrical conductors which are appropriately sized according to an electrical load anticipated for the number and expected utilization of the modules.

In one embodiment, each module will include a service unit including a structural member and an electronic circuit board. An exemplary structural member will include a five sided box formed of folded sheet metal, diecast metallic alloy, polymer, or other appropriate structural material. The circuit board will be mechanically coupled to the structural member and will support an electronic coupling device such as, for example (and without limitation), a USB receptacle as known in the art. In addition, certain embodiments of the invention will include an illumination device such as, for example and without limitation, a light emitting diode (LED). In a further aspect of certain embodiments, light will be conducted from the illumination device to an external surface adjacent to the coupling device by a solid-state light pipe.

In a still further aspect of certain embodiments, the module also includes a cover portion. The cover portion will be arranged to be mechanically coupled to, and supported by, the structural member of the service unit. In addition, in certain embodiments, the cover portion will be independently directly coupled to the service location with a separate fastener. In certain embodiments, two fasteners will be used to couple the service module to the service location and a third fastener will be employed to couple the cover to the service location. In various embodiments, the fasteners so employed will include one or more of a screw, a nail, an adhesive material, a bolt, and a rivet.

In still other embodiments of the invention, one or more of the service module and the cover will be coupled to the service location employing a bonding techniques such as, for example, thermal welding, arc welding, ultrasonic welding, laser welding, or any other bonding method known or that becomes known in the art.

Certain embodiments of the invention will include a cover portion including one or more hooks. The hooks will be sized and configured to support a personal article. For example, a typical hook might be well adapted to support a woman's purse or pocketbook, a man or woman's jacket, a child's coat, a briefcase, or any other personal article that would be conveniently disposed thereon while a user, for example, eats a meal or enjoys a drink at the service location.

Exemplary physical configurations and designs are illustrated in the attached figures and it will be understood that one of skill in the art, having perceived the utility of the present invention, will readily derive other valuable and serviceable configurations of the invention, all of which are intended to fall within the scope of the present disclosure.

In certain embodiments, the cover portion will exhibit a longitudinal axis, with the hook disposed adjacent to one end of the cover portion. Certain embodiments of the invention will be arranged for operative mounting with the longitudinal axis in a vertical orientation. In contrast, certain embodiments of the invention will be arranged for operative mounting with the longitudinal axis in a horizontal orientation. In other embodiments, mounting of a longitudinal axis will be made at any useful oblique angle with respect to the vertical.

The following description is provided to enable any person skilled in the art to make and use the disclosed inventions and sets forth the best modes presently contemplated by the inventors of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in schematic form in order to avoid unnecessarily obscuring the substance disclosed. These and other advantages and features of the invention will be more readily understood in relation to the following detailed description of the invention, which is provided in conjunction with the accompanying drawings.

It should be noted that, while the various figures show respective aspects of the invention, no one figure is intended to show the entire invention. Rather, the figures together illustrate the invention in its various aspects and principles. As such, it should not be presumed that any particular figure is exclusively related to a discrete aspect or species of the invention. To the contrary, one of skill in the art would appreciate that the figures taken together reflect various embodiments exemplifying the invention as a whole.

Correspondingly, referenced throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### BRIEF DESCRIPTION OF THE DRAWINGS

FIG. 1 shows, in perspective view, a portion of a charging system prepared according to principles of the invention;

FIG. 2 shows, in perspective view, further aspects of an exemplary charging system prepared according to principles of the invention;

FIG. 3 shows, in perspective view, details of a localized outlet of a charging system prepared according to principles of the invention;

FIG. 4 shows, in perspective view, a portion of a cover module for a localized outlet of a charging system prepared according to principles of the invention;

FIG. 5 shows, in posterior perspective view, portions of a localized outlet of a charging system prepared according to principles of the invention;

FIG. 6 shows, in perspective view, an assembly of a localized outlet for a charging system prepared according to principles of the invention;

FIG. 7 shows, in perspective view, a portion of a service module for a localized outlet of a charging system prepared according to principles of the invention;

FIG. 8 shows, in additional detail, a perspective view of a service module for a localized outlet of a charging system prepared according to principles of the invention;

FIG. 9 shows, in perspective view, a further aspects of a localized outlet for a charging system prepared according to principles of the invention;

FIG. 10 shows, in perspective view, a portion of a convenience feature of a localized outlet for a charging system prepared according to principles of the invention;

FIG. 11 shows, in perspective view, further aspects of a localized outlet for a charging system prepared according to principles of the invention;

FIGS. 12A, 12B and 12C show, respectively, applications of a lateral localized power outlet to a bar stool, a study carrel, and a dining table respectively;

FIG. 13 shows, in perspective view, further aspects of a localized outlet for a charging system prepared according to principles of the invention;

FIG. 14 shows, in perspective view, further aspects of a service module for a localized outlet of a charging system prepared according to principles of the invention;

FIG. 15 shows, in perspective view, a localized outlet assembly for a charging system prepared according to principles of the invention;

FIG. 16 shows, in perspective view, further aspects of a service module for a localized outlet of a charging system prepared according to principles of the invention;

FIG. 17 shows, in perspective view, further aspects of a service module for a localized outlet of a charging system prepared according to principles of the invention;

FIG. 18 shows, in perspective view, a localized outlet assembly for a charging system prepared according to principles of the invention;

FIG. 19 shows, in schematic cutaway perspective view, portions of a charging system prepared according to principles of the invention;

FIG. 20 shows, in schematic cutaway perspective view, portions of a charging system prepared according to principles of the invention;

FIG. 21, shows further aspects of a charging system prepared according to principles of the invention;

FIG. 22 in schematic cutaway perspective view, portions of a charging system, including an alternative mains power connection, prepared according to principles of the invention; and

FIG. 23 shows further aspect of a charging system, including alternative mains power connection, prepared according to principles of the invention.

### DETAILED DESCRIPTION

This description is provided to enable any person skilled in the art to make and use the disclosed inventions and sets forth the best modes presently contemplated by the inventors of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in schematic form in order to avoid unnecessarily obscuring the substance disclosed.

In the course of the present disclosure, the terms substantially and generally will be used to modify various descriptions. The term substantially is intended to mean within the normal manufacturing tolerances, as such would be understood by one of skill in the art, for an item of a comparable nature at the time of manufacture. The term generally is intended to imply less precision than substantially, rather to simply suggest that a particular characteristic would be perceived by the ordinary viewer examining the item. As such, an item that generally exhibits a characteristic may also substantially exhibit that characteristic, but need not. Conversely, an item that substantially exhibits a characteristic will also generally exhibit that characteristic.

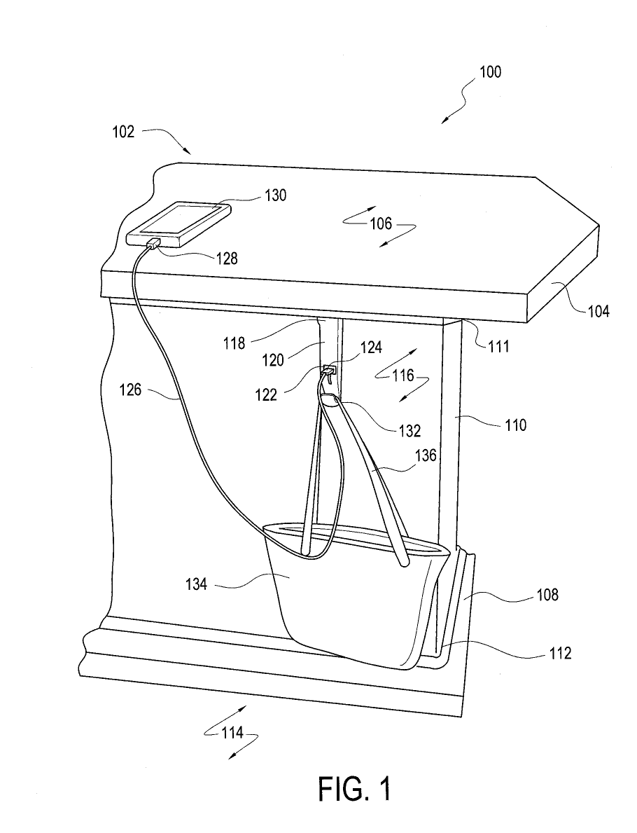

FIG. 1 shows, in perspective view, a portion of a charging system 100 for a personal communication device as employed in the context of a beverage service bar 102. One of skill in the art will readily ascertain in the figure common features of a service bar including a server 104 having a server top surface region 106, a base portion 108 disposed downwardly of the server top 106, and a pedestal portion 110 disposed between the server top surface region 106 and the base portion 108 and coupled to each at respective upper 111 and lower ends 112 thereof. The base portion 108, in turn, is supported on an upper surface region of a floor 114, which bears the weight of the service bar 102.

Coupled to, and supported by, a proximal surface region 116 of pedestal 110 is an exemplary localized outlet 118 of the charging system 100 prepared according to principles of the invention. As will be further discussed below, the illustrated localized outlet 118 includes a cabinet 120 and an electronic receptacle 122. Electronic receptacle 122 is shown in use, functionally coupled to a distal end 124 of a typical charging cable 126. A proximal end 128 of the charging cable 126 is received within and coupled to a charging receptacle of a personal electronic device 130. In light of the present figure, one of skill in the art will readily appreciate that the illustrated location of the localized outlet 118 on the surface region 116 of pedestal 110 allows convenient placement of the personal electronic device 130 on surface region 106 of server 104 within the length constraints of typical charging cable 126.

In the illustrated embodiment, the localized outlet 118 also includes a convenience feature, here illustrated as a pocketbook hook 132. As illustrated in the exemplary embodiment presented, the pocketbook hook 132 is arranged and configured to support a pocketbook or other handbag 134 by a handle 136 or other coupling feature.

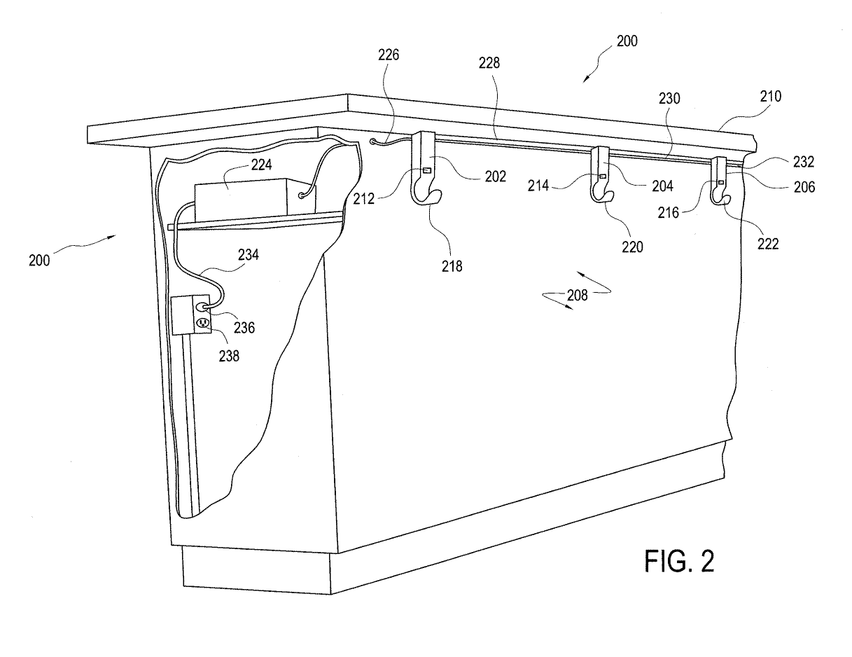

FIG. 2 shows a further aspect of an exemplary charging system 200 prepared according to principles of the invention. As shown, charging system 200 includes a plurality of localized outlets e.g., 202, 204, 206 respectively coupled to a proximal surface region 208 of a service bar 210. Each localized outlet 202, 204, 206 includes a respective electronic receptacle e.g., 212, 214, 216 and a respective convenience feature 218, 220, 222.

As illustrated, the localized outlets 202, 204, 206 are respectively electrically coupled to one another, and to a power supply module 224 in parallel daisychain configuration by a plurality of electrical conductors e.g., 226, 228, 230, 232. It will be appreciated, however, that the configuration shown is merely exemplary, and that other electrical configurations including, for example, series coupling arrangements, star coupled arrangements, and other arrangements known in the art or yet to be discovered, are intended to be included within the scope of the present disclosure.

In one embodiment of the invention, the power supply module 224 includes a power cord 234 with a standard plug 236. The standard plug 236 is adapted to be coupled to, and receive power from, a mains power receptacle 238. Naturally, the mains power receptacle will supply electrical voltage and current at levels determined according to local convention.

In certain embodiments, the power supply module 224 will convert mains power to the specific voltage to be output at, and common to, all of the electronic receptacles, e.g., 212, 214, 216. Thus, for example, (and as will be further discussed below) where the electronic receptacle is a standard Universal Serial Bus (USB) receptacle each conductor segment 226, 228, 230, 232 will provide a voltage substantially equal to 5.0 V (generally within the tolerance of the USB standard). Accordingly, the conductor segments 226, 228, 230, 232 will include conductors sized to sustain the current anticipated in the event that a full complement of localized outlets are operated at full load, plus an increment for a safety factor.

In other embodiments, the power supply module 224 will be arranged and configured to receive mains power and output to the conductor segments 226, 228, 230, 232 an alternative voltage that differs both from the mains supply voltage received at receptacle 238, and from the output voltage supplied to devices at electronic receptacles 212, 214, 216. In such embodiments, the localized outlets 202, 204, 206 would generally each include a power conversion device capable of receiving as an input the alternative voltage and producing an output voltage required to correctly supply the respective electronic receptacles 212, 214 and 216 (which output voltage may be the same or different as between the various electronic receptacles).

For example, in certain embodiments, the alternative voltage will be an intermediate voltage. Thus, for example, the intermediate alternative voltage will, in certain embodiments, be chosen to have a relatively safe value, as opposed to mains voltage, while still being substantially above the voltage output at the electronic receptacles 212, 214, 216. Consequently, it will be possible to more readily stabilize the output voltage of the electronic receptacles 212, 214, 216. In addition, as will be understood by one of skill in the art, smaller conductors (i.e. smaller diameter) may be used in the conductor segments 226, 228, 230, 232 compared to those that would be necessary if a lower voltage (e.g., output voltage) were supplied by the power supply module 224 directly to the outputs of electronic receptacles 212, 214, 216.

One of skill in the art will appreciate that a variety of standard values are likely to be desirable from a commercial perspective as intermediate voltages. Thus, for example, in certain embodiments of the invention, an intermediate voltage supply between the power supply module 224 and respective power conversion devices will have a value of, for example, 6 V, 9 V, 12 V, 24 V, 32 V and 48 V. Again, these values are merely exemplary, and a wide variety of other alternative voltages will be employed in respective embodiments according to the requirements of a particular application and circumstance.

It will also be appreciated that in certain embodiments an alternative voltage higher than the mains voltage will be employed. While less common, such a configuration remains within the scope of the present disclosure.

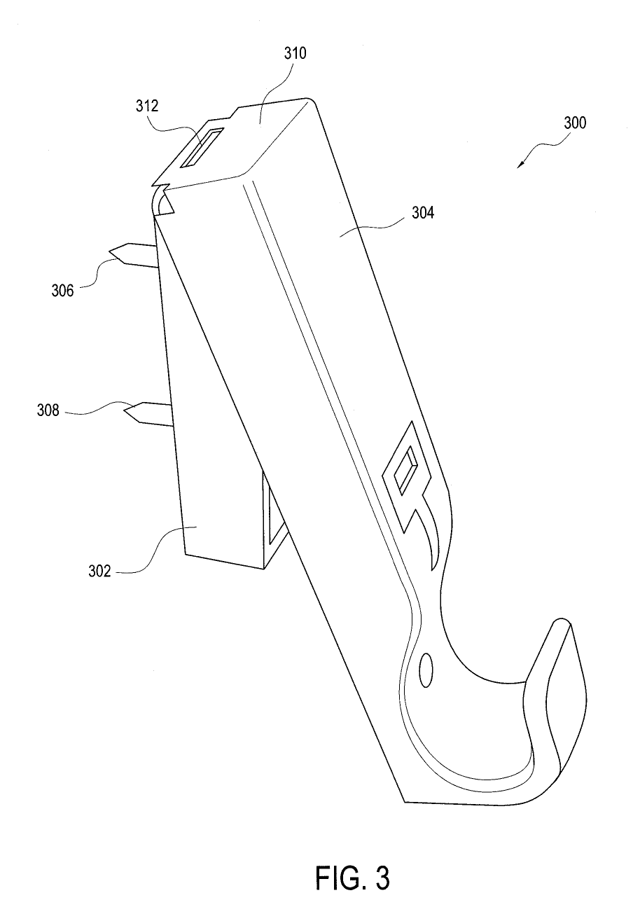

FIG. 3 shows, in perspective view, details of one embodiment of a localized outlet 300 prepared according to principles of the invention. The localized outlet 300 includes a service module 302 and a cover module 304. Among other features, the service module 302 includes first and second apertures (not visible) arranged and configured to receive respective first 306 and second 308 fasteners therethrough. The fasteners, which may be any fastener appropriate to a particular application that is known or becomes known in the art will, in various embodiments, include (without limitation) a wood screw, a metal screw, a bolt, a lag bolt, a nail, a barbed nail or a rivet. One of skill in the art will appreciate that, in certain embodiments, the function of the fastener will be served instead by an adhesive such as a physical adhesive or a chemical adhesive, or by weldment (such as, electrical weldment, a gas weldment, a laser weldment, or an ultrasonic weldment) or any other fastening method that is known or becomes known in the art.

The cover module 304 includes an upper surface region 310 with an aperture 312. The aperture 312 is arranged and configured to receive a protrusion (not shown) correspondingly located on an upper surface region of the service module 302. As will be further described below, this coupling allows for a substantially fixed connection to be effected between the service module 302 and the cover module 304 after mounting and wiring of the service module 302.

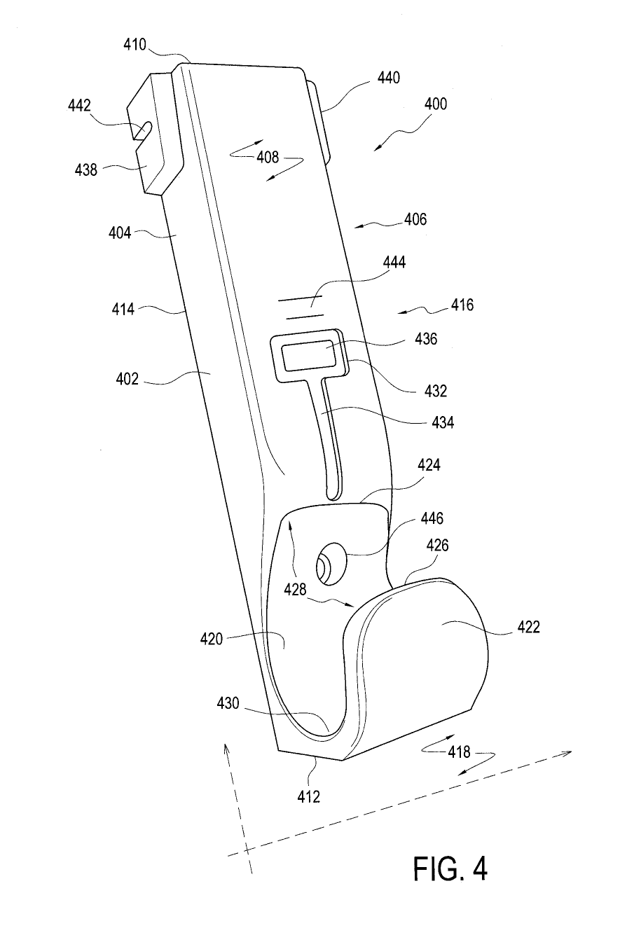

FIG. 4 shows, in anterior perspective view, a portion of a further cover module 400 prepared according to principles of the invention. Cover module 400 includes a body member 402 having first 404 and second 406 side surface regions, a top surface region 408, and first 410 and second 412 end surface regions. Side surface regions 404 and 406 are disposed in generally parallel spaced relation to one another. Likewise, end surface regions 410 and 412 are disposed in generally parallel spaced relation to one another.

In the exemplary embodiment shown, the first 404 and second 406 side surface regions, the top surface region 408, and the end surface regions 410, 412 include substantially planar portions. One of skill in the art will appreciate, however, that alternative configurations and arrangements are possible and intended to be within the scope of this disclosure.

Surface region 404 terminates in one dimension at an edge region 414. Surface region 406 terminates at a corresponding edge region 416 (not visible). In the case of the illustrated cover module 400, edge regions 414 and 416 are each generally linear and disposed in generally parallel spaced relation to one another. Together, edge regions 414 and 416 define a rear plane 418 of the cover module 400. Rear plane 418 is disposed in generally parallel spaced relation to top surface region 408.

As illustrated, surface region 408 evolves in a direction towards end surface region 412 into a further arcuate surface region 420. Surface region 420 forms an internal surface of a hook 422, such that a first end 424 and a second end 426 of surface region 420 defines an aperture 428 for receiving, for example, a handbag strap. A lower portion 430 of surface region 420 consequently constitutes a supporting surface region for such an exemplary handbag strap. In the illustrated embodiment, surface region 408 includes an aperture 432 within which is present an outward surface 434 of a light pipe or lens. The light pipe surface 434 includes a further aperture 436 within which a USB receptacle is disposed when the cover module 400 is in use.

The cover module 400 also includes first 438 and second 440 protrusions, each of which has a receiving slot e.g. 442 therethrough. The receiving slots are shaped and configured to receive respective portions of insulated electrical conductors therewithin when the cover module 400 is in use. Surface region 408 will, in certain embodiments, include a label, engraved indicia, or other legend or marking 444 for instructional or trademark purposes. In addition, surface region 420 includes a further aperture 446. As will be further described below, aperture 446 is arranged to receive a fastener therethrough.

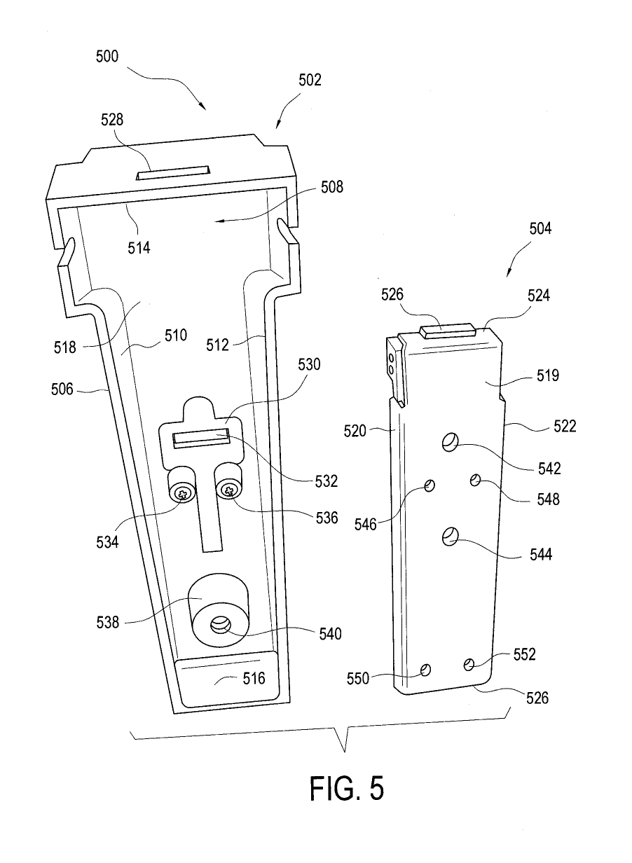

FIG. 5 shows, in posterior perspective view, portions of a localized outlet 500 prepared according to principles of the invention. The localized outlet 500 includes a further exemplary features.

Cover module 502 includes a body member 506 having a recess 508. Recess 508 is defined by internal surface regions including: first 510 and second 512 internal side surface regions, first 514 and second 516 internal end surface regions, and an internal front surface region 518.

Service module 504 includes a back surface region 519, first 520 and second 522 side surface regions, and first 524 and second 526 end surface regions. End surface region 524 of the service module 504 includes a protrusion 525. Internal end surface region 514 of the cover module includes an aperture 528.

Recess 508 is sized and configured to receive the service module 504 therewithin. This mating is facilitated by a similarity in size and shape of protrusion 526 and aperture 528, such that when the cover module 502 and service module 504 are assembled together, at least a portion of protrusion 526 is received and disposed within aperture 528.

Although the protrusion 526 is shown as a generally rectangular solid, one of skill in the art will appreciate that a wide variety of other shapes and configurations will also be used in corresponding embodiments of the invention. For example, protrusion 528 will be, in respective embodiments, generally circular cylindrical in form (including circular cylindrical solids and hollow circular cylinders), polygonal in form, triangular in form, pyramidal in form (including truncated pyramidal), conical in form (including truncated conical) of a random perimeter, or of any other shape and size appropriate to the requirements of a particular application. It will further be understood that the corresponding aperture 528 will be generally similar in shape to the selected protrusion so as to allow a functional coupling between the protrusion and aperture.

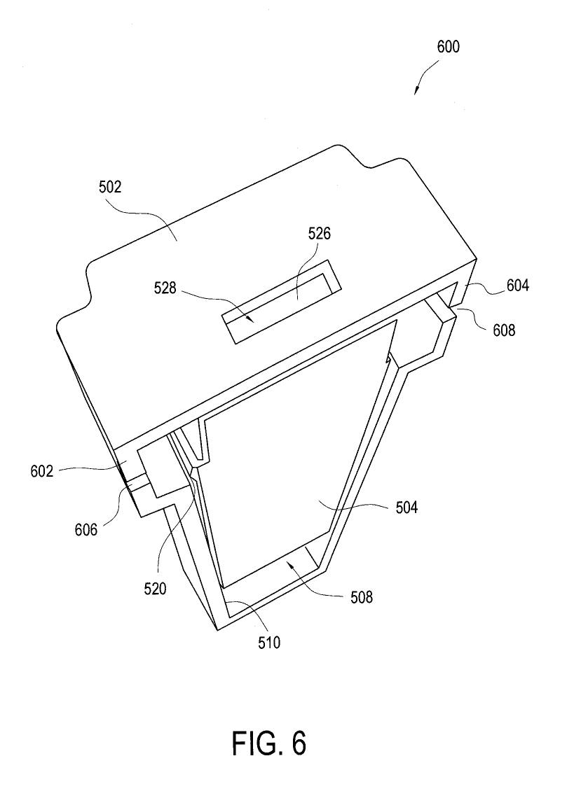

Referring now to FIG. 6 as well as FIG. 5, one sees in FIG. 6 a localized outlet assembly 600 prepared according to principles of the invention. The assembly 600 corresponds to an assemblage of the cover module 502 and service module 504 illustrated in FIG. 5. As will be apparent to the reader, service module 504 is sized and configured to fit within a recess 508 of the cover module 502. Accordingly, and for example, side surface region 520 of the service module 504 is disposed in proximity to internal side surface region 510 of the cover module 502. Likewise, protrusion 526 of the service module 504 is visible disposed within aperture 528 of the cover module 502.

The reader will note that the exemplary cover module 502 incorporates further protrusions 602, 604 each of which includes a respective slot 606, 608. The slots 606, 608 are adapted to receive portions of electrical conductors therewithin. Upon reflection, the reader will understand that the service module 504 can be fixed in place and wiring of electrical conductors can be installed. Thereafter, the cover module 502 can be installed over the service module, at which time the electrical conductors (not shown) can slide into the respective slots.

Referring again to FIG. 5, the reader will note that the cover module 502 includes a light-pipe element 530. The light pipe element 530 is arranged and configured to allow light to be conducted from within the recess 508 outwardly of the cover module, so as to illuminate an aperture 532 where a USB receptacle or other electronic receptacle will be found. In addition, the light pipe element 530 provides aesthetic benefit, making the local outlet 500 visible and attractive to a user.

In certain embodiments of the invention, the light pipe 530 will be available in a variety of colors, so as to provide a correspondingly colored illumination of the receptacle aperture 532. In certain embodiments, and in methods according to the invention, the color of the light pipe 530 will be customizable—i.e., selected according to a customer's preference. Insertion of the desired color of light pipe will be performed, in various embodiments of the invention, during original assembly and/or during installation of the localized outlet 500. In addition, in certain embodiments, the light pipe 530 will be removable and replaceable with a replacement light pipe of the same or a different color at any time during the lifetime of the localized outlet 500.

In the illustrated embodiment, the light pipe element 530 is coupled to the cover module 502 with first 534 and second 536 fasteners (here illustrated as Phillips head screws). One of skill in the art will appreciate that any appropriate fastener will be employed in a respective embodiment of the invention. A variety of exemplary fasteners, as listed above in relation to the service module of FIG. 4, would likewise be applicable to this function, as would others.

Also apparent within the recess 508 of cover module 502 is a standoff column 538. A bore (i.e., a through hole) 540 is visible within the standoff column 538. Likewise, first 542 and second 544 bores (i.e., through holes) are visible in back surface region 519 of service module 504. Additional bores/through holes 546, 548, 550, 552, are also present in back surface region 519 of service module 504.

A method of employing the local receptacle 500, illustrated in FIGS. 5 and 6 will include coupling a circuit board to the service module 504 by applying a plurality of fasteners through the circuit board and through bores 546, 548, 550, 552. The plurality of fasteners will include any appropriate fastener such as, for instance, a threaded screw (where through holes 546, 548, 550, 552 may be pre-threaded).

Thereafter, the service module 504 will be disposed adjacent an appropriate surface of, for example, a service bar and first and second fasteners will be disposed through bores 542 and 544 to fasten the service module to the service bar.

Thereafter, insulated wires including electrical conductors will be applied to the circuit board of the service module. The conductors will ultimately be functionally coupled to a power supply or, in some circumstances directly to mains power.

Once the wires are in place, a cover module 502 is coupled to the service module 504 by placing protrusion 526 within aperture 528 and then pivoting the cover module 502 into place over the service module 504. In certain embodiments, a fastener is thereafter applied through aperture 540. For example in certain embodiments, a wood screw is driven through aperture 540 and into the appropriate surface of the service bar.

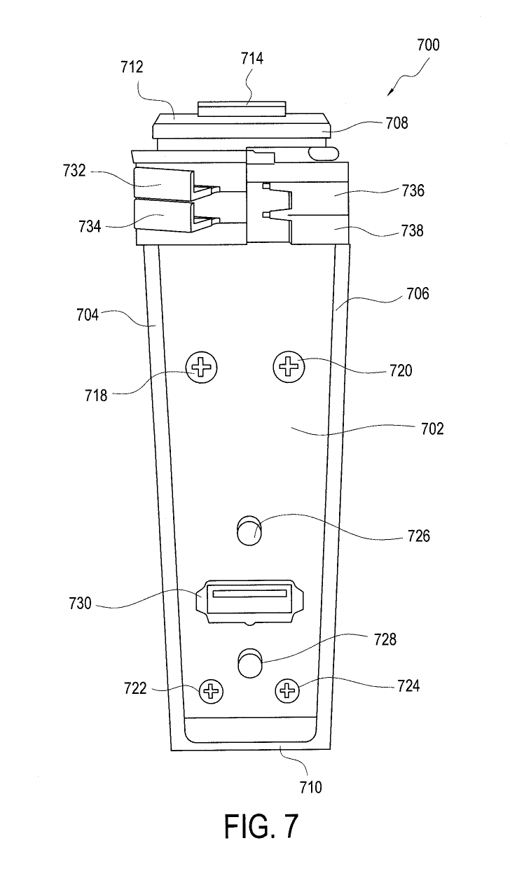

FIG. 7 shows a further aspect of a service module 700 prepared according to principles of the invention. Service module 700 includes a circuit board 702 disposed within sidewalls 704, 706 and end walls 708, 710 of the service module 700. External surface region 712 of end wall 708 supports a protrusion 714 like that described above (e.g. 526 of FIG. 5). Fasteners (here shown as Phillips head screws) 718, 720, 722, 724 are disposed through apertures in the circuit board and corresponding apertures in a rear wall of the service module (not shown) to substantially fixedly couple the circuit board 702 to the balance of the service module 700.

In the illustrated embodiment, the circuit board 702 includes, among other components, first 726 and second 728 light emitting diodes (LEDs) and a USB receptacle component 730. The exemplary circuit board 702 also includes quick connect connectors 732, 734, 736, 738 for the ready coupling of electrical supply connectors to the circuit board 702. Of course, one of skill in the art will appreciate that a wide variety of other coupling mechanisms including soldering, crimp on connectors, screw lugs, and the like will be used in various corresponding applications of the invention. Likewise, the number and arrangement of LEDs and of USB receptacles will also vary from embodiment to embodiment according to the preferences and needs of a particular installer and/or user.

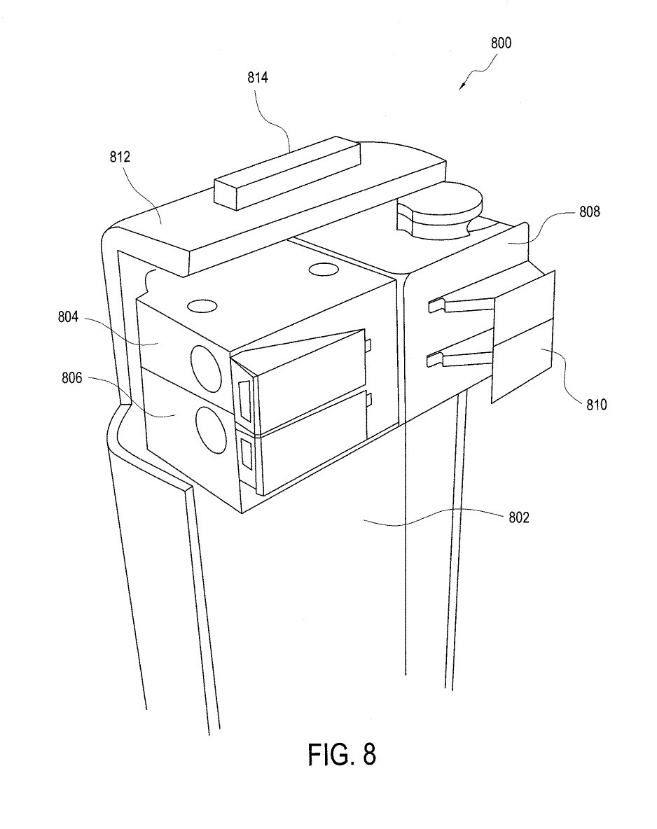

FIG. 8 shows, in additional detail, a service module 800 including a circuit board 802 and quick connect connectors 804, 806, 808, 810. Also visible in additional detail is an end surface region 812 of the service module 800 including a protrusion 814 for coupling to a corresponding cover module.

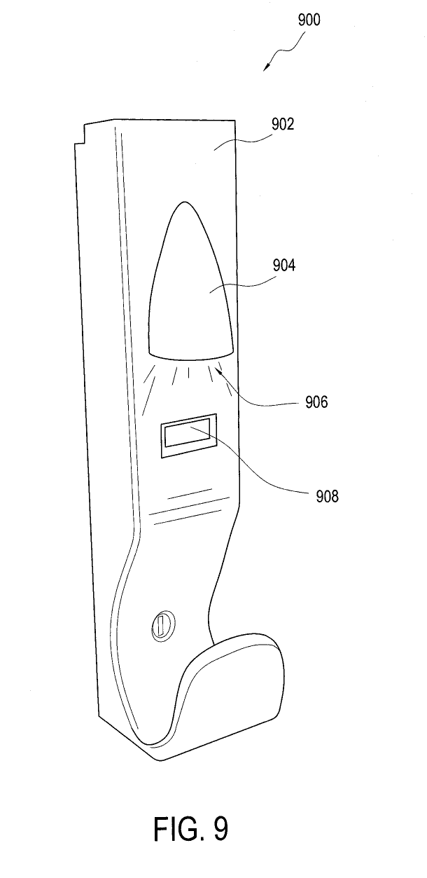

FIG. 9 shows a further embodiment of a local outlet module 900 according to principles of the invention including, inter alia, an alternative illumination feature. Local outlet module 900 includes a cover module 902 with a protruding light shield 904. The protruding light shield 904 is configured to include an aperture 906 at a lower end thereof. An LED, supported by a corresponding circuit board, is disposed within the light shield 904 such that light produced by the LED is emitted through the aperture 906 to illuminate, for example, a USB receptacle 908. In various embodiments, the USB receptacle will include a light pipe as previously described. In other embodiments, the USB receptacle will be illuminated primarily by the LED within the protruding light shield 904 and the cover module 902 will not include a light pipe.

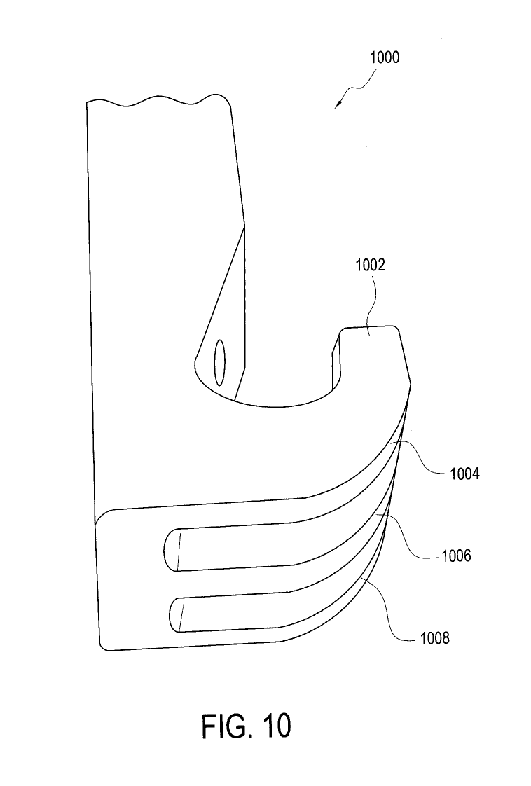

FIG. 10 shows a portion of a further embodiment of a localized outlet 1000, prepared according to principles of the invention. The localized outlet 1000 includes a hook portion 1002. The hook portion 1002 includes one or more ribs e.g., 1004, 1006, 1008. One of skill in the art will appreciate that the configuration of a hook including features such as the illustrated ribs will be beneficial so as to facilitate consistent and material-efficient molding and/or casting, and/or to provide a high strength-weight ratio for the resulting hook.

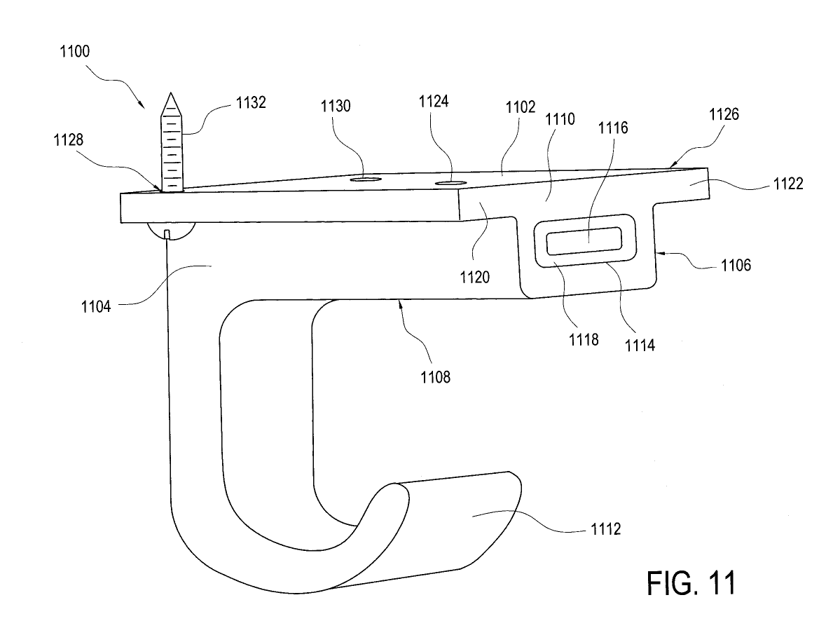

FIG. 11 shows, in perspective view, certain features of a further embodiment of the invention including a localized outlet 1100. In contrast to the various localized outlets discussed above (which, as previously described, are configured for mounting to a generally vertical surface) localized outlet 1100 is configured for mounting to a generally horizontal surface. Accordingly, such a localized outlet is termed a lateral localized outlet.

The exemplary lateral localized outlet 1100 includes a body portion having a top surface region 1102, first 1104 and second 1106 side surface regions, a bottom surface region 1108, a front surface region 1110, and a hook portion 1112. As illustrated, the front surface region includes an aperture 1114 within which is disposed an electrical charging receptacle 1116.

In the illustrated embodiment, the charging receptacle 1116 is shown as a USB receptacle. In addition, a light pipe or lens 1118 is disposed within aperture 1114 and radially outwardly of charging receptacle 1116. Also, as illustrated, the lateral localized outlet 1100 includes first 1120 and second 1122 mounting features. The mounting features will, in various embodiments, be configured as lugs, ears, or other protrusions from the first 1104 and second 1106 side surface regions.

In the illustrated embodiment, the mounting features 1120, 1122 include respective bores or mounting holes 1124, 1126 (not visible), 1128, 1130 at, e.g., four corners of the localized outlet 1100. These holes are arranged and configured to receive respective portions of fasteners therewithin. One exemplary fastener 1132 (shown, for example, as a roundhead wood screw) is presented for illustrative purposes. In other embodiments, a counter sunk flathead wood screw will be employed. More generally, having the benefit of the present disclosure, one of skill in the art will readily perceive other mounting arrangements that should properly be considered to be within the scope of the present disclosure.

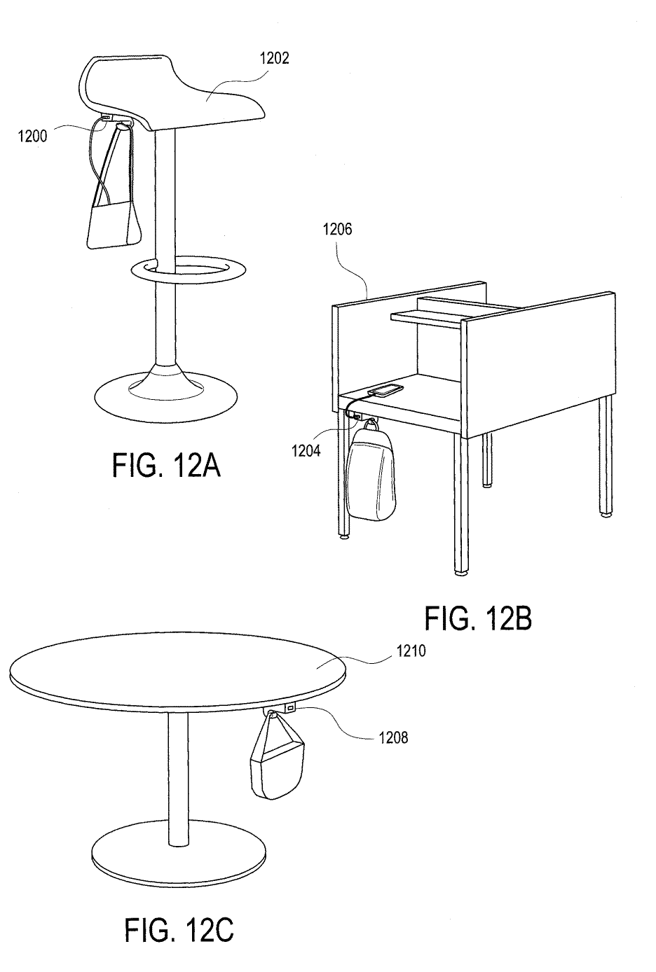

FIG. 12A shows a lateral localized outlet 1200 mounted to the underside of a barstool 1202. FIG. 12B shows a lateral localized outlet 1204 mounted to the underside of a library study carrel 1206. FIG. 12C shows a lateral localized outlet 1208 mounted to the underside of a dining table 1210. In light of the present disclosure, one of skill in the art will readily apprehend a wide variety of horizontal surfaces to which one or more lateral localized outlets will be beneficially mounted. It will, moreover, be understood that such locations will not be limited to fixed locations, but may also include examples in which a localized outlet is mounted within a vehicle, such as a bus, an automobile, an airplane, a ship, a bicycle, etc. In addition, vertically and laterally mounted localized outlets will, in certain applications, be mounted directly to walls, doors, door frames, window frames, windowsills, kiosks, posts, ski lift chairs, bathroom walls and fixtures, mirrors, and other features and/or locations without limitation.

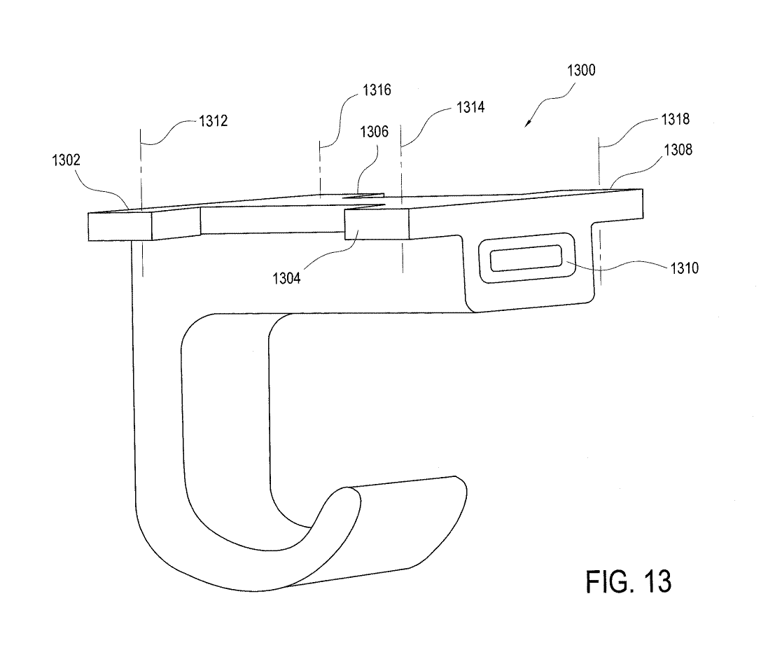

FIGS. 13-18 show further aspects and characteristics of various lateral localized outlets. These aspects and characteristics are in no way intended to be limiting of the invention but, rather, are merely exemplary of a wide variety of arrangements and embodiments that will occur to the skilled practitioner who has had the benefit of the present disclosure.

FIG. 13 shows, in perspective view, certain additional features of a lateral localized outlet 1300 prepared according to principles of the invention. In particular, outlet 1300 largely resembles outlet 1100 of FIG. 11. However, whereas the mounting features 1120, 1122 of outlet 1100 are coextensive in length with side surface regions 1104 and 1106, outlet 1300 embodies mounting features localized to the corners. Thus, as shown, outlet 1300 includes four mounting lugs 1302, 1304, 1306, 1308 at respective corners of outlet 1300.

In certain embodiments an outlet, such as outlet 1300, will have internal surfaces defining a cavity therewithin, and a circuit board substantially permanently mounted within the cavity. The circuit board will support an electrical receptacle 1310.

During a typical installation process, supply wires will be connected to the circuit board and the outlet 1300 will be mounted to a downward-facing substantially horizontal surface by, for example, the application of four respective fasteners through mounting holes disposed with respective longitudinal axes 1312, 1314, 1316, 1318 through the lugs 1302, 1304, 1306, 1308. Consequently, and in contrast to the vertically-mounted localized outlet described above with respect to, e.g., FIG. 4, outlet 1300 includes a single body member and does not include a service module. In other embodiments, however a lateral localized outlet will include a service module and a separate cover module.

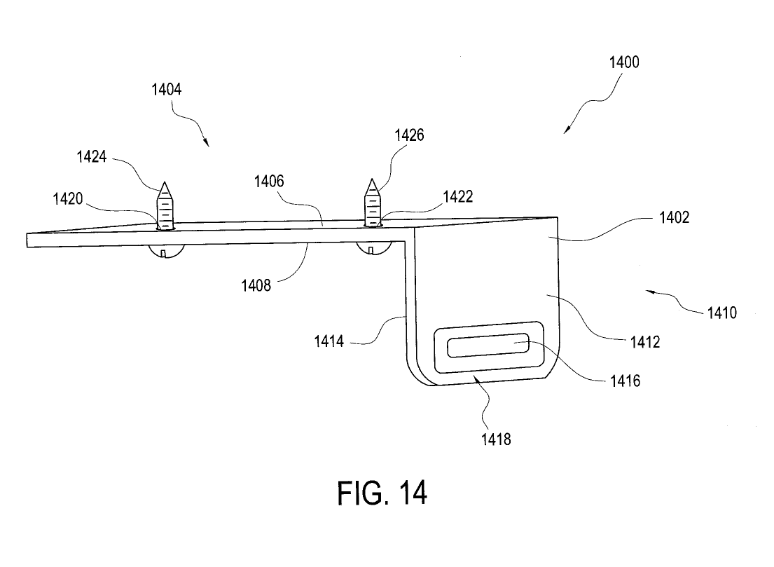

FIG. 14 shows a portion of a service module 1400 for a lateral localized outlet such as would be employed in a charging system prepared according to principles of the invention. Service module 1400 includes a substantially rigid member 1402 having a first portion 1404 with upper 1406 and lower 1408 substantially planar surface regions. Generally normal to first portion 1404 is a second portion 1410 of member 1402. Second portion 1410 includes first 1412 and second 1414 substantially planar surface regions.

In light of the foregoing disclosure, one of skill in the art will appreciate that, in operation, service module 1400 will be substantially fixedly coupled to a device such as a circuit board which, in turn, embodies a USB receptacle 1416. While, for clarity of presentation, the circuit board is not shown, it will be understood that the USB receptacle 1416 will be accessible through an aperture 1418 in surface region 1412.

As illustrated, first 1420 and second 1422 mounting holes in first portion 1404 are arranged to receive respective mounting screws 1424, 1426 for mounting the service module 1400 to a generally horizontal, generally downward facing surface (it will be appreciated that various localized outlets according to principles of the invention will be mounted at any useful angle with respect to the vertical). According to one method of the invention, after mounting of the service module 1400 appropriate supply wiring will be completed to the corresponding circuit board of the module. Thereafter, a housing module will be mounted so as to generally or substantially enclose the circuit board.

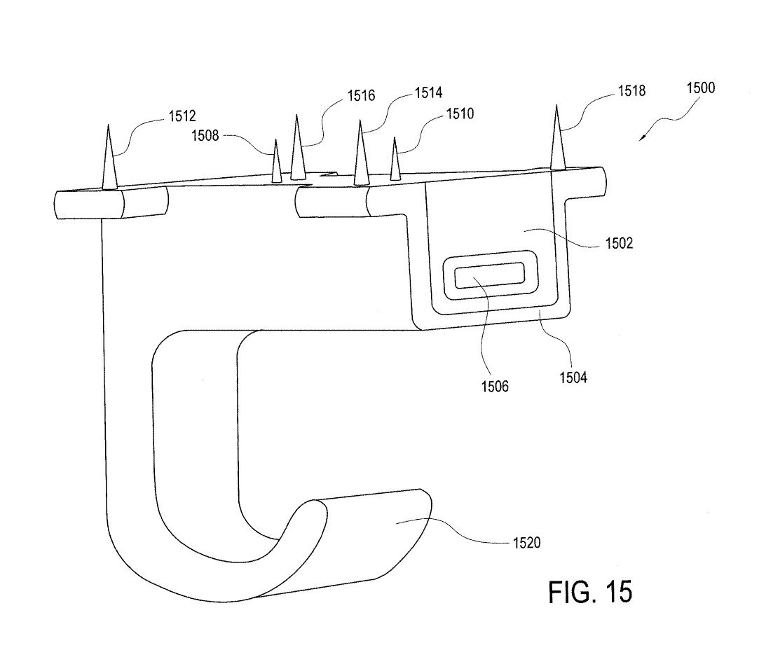

FIG. 15 shows, in schematic perspective view, one embodiment of a lateral localized outlet 1500 of a charging system prepared according to principles of the invention. The illustrated outlet includes a service module 1502 and a cover module 1504. Like service module 1400 of FIG. 14 service module 1502 supports a circuit board and a USB receptacle 1506. Service module 1502 is adapted to be coupled to a horizontal surface with, for example, first 1508 and second 1510 fasteners. Thereafter, supply wiring to the circuit board is completed.

After completion of the supply wiring, cover module 1504 is disposed in position, so as to enclose the circuit board, and fastened in place by the application of, for example, respective fasteners 1512, 1514, 1516, 1518. Accordingly, the service module 1502 and cover module 1504 are placed in a substantially fixed and permanent relation to one another where the circuit board is generally enclosed and a hook portion 1520 of the localized outlet 1500 is arranged in a useful orientation.

Upon careful examination, it will be noted that the weight of any article supported by the hook portion 1520 will be transferred through the cover module 1504 to the corresponding fasteners 1512, 1514, 1516, 1518, substantially bypassing the service module 1502 and related fasteners 1508, 1510.

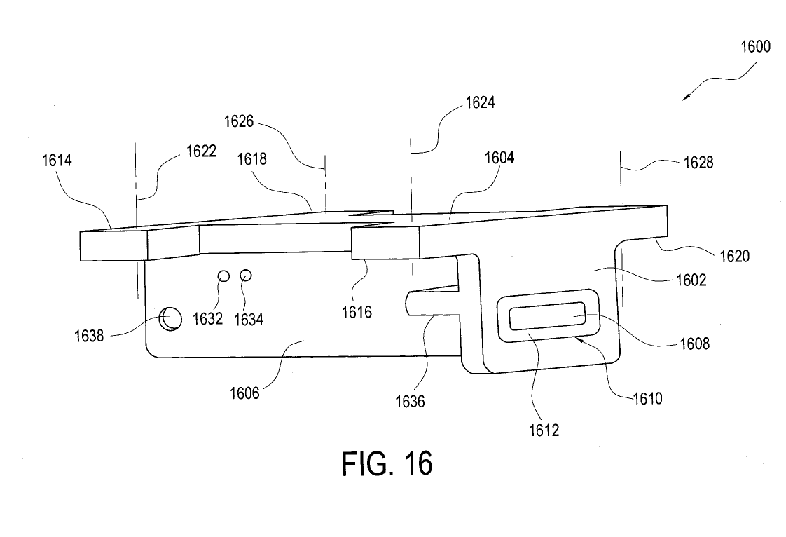

FIG. 16 shows, in schematic perspective view, an alternative embodiment of a service module 1600 for a localized outlet prepared according to principles of the invention. Service module 1600 includes a front portion 1602 and a top portion 1604, as well as a first side portion 1606 and a second side portion (not visible). A recess between internal surface regions of the first 1606 and second side portions is sized and configured to have a circuit board substantially fixedly disposed therewithin. The circuit board supports an electrical charging receptacle 1608 (such as a USB receptacle) which is accessible through an aperture 1610 of the front portion 1602. In certain embodiments, and as illustrated, an illuminated light pipe or bezel 1612 is also disposed within the aperture 1610 and surrounding the receptacle 1608. Top portion 1604 includes, for example, four protrusions or mounting lugs 1614, 1616, 1618, 1620.

Through each of the mounting lugs is disposed a respective mounting hole defining four longitudinal axes 1622, 1624, 1626, 1628 respectively. During installation of the service module, the mounting holes will receive therewithin portions of respective mounting screws or other fasteners, such that the service module is substantially fixedly coupled to a supporting member within a user's environment.

In certain embodiments of the invention, and as illustrated, the side portions, e.g., 1606 of the service module 1600 will include, for example, first 1632 and second 1634 apertures, where the apertures 1632, 1634 are arranged and configured to receive power supply wiring.

In additional embodiments of the invention, and as illustrated, the side portions of the service module 1600 will include respective additional structural protrusions, e.g., 1636, and further respective through holes, e.g., 1638. In certain embodiments, a through hole 1638 will be internally threaded to receive, for example, a portion of a machine screw therewithin.

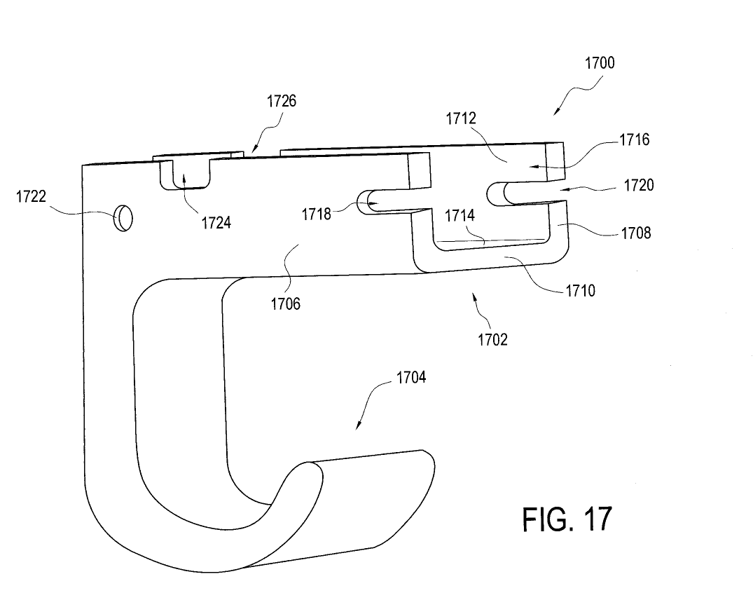

FIG. 17 shows, in schematic perspective view, a portion of a cover module 1700 compatible, for example, with service module 1600 of FIG. 16. Cover module 1700 includes a first cabinet portion 1702 and a second hook portion 1704. The cabinet portion 1702 includes first 1706 and second 1708 side portions and a bottom portion 1710. Internal surface regions, e.g., 1712, 1714 of side portion 1708 and bottom portion 1710 respectively define a cavity 1716 within the cabinet portion 1702. As will be further discussed below, at least a portion of a service module such as service module 1600 will be disposed within this cavity 1716 when the corresponding localized outlet is in use.

In certain embodiments, and as illustrated, side portion 1706 and 1708 will include respective slots 1718, 1720 (or functionally similar features) arranged and configured to align with protrusions, e.g., 1636 of the service module 1600 when in use. Additionally, side portions 1706 and 1708 will include respective through holes, e.g., 1722. The through holes, e.g., 1722, will be arranged and configured to align with the through holes, e.g., 1638 of the service module 1600 when in use. Further, side portions 1706 and 1708 will, in certain embodiments, include notches 1724, 1726 respectively configured and arranged to align with apertures, e.g. 1632, 1634 of the service module 1600 when in use.

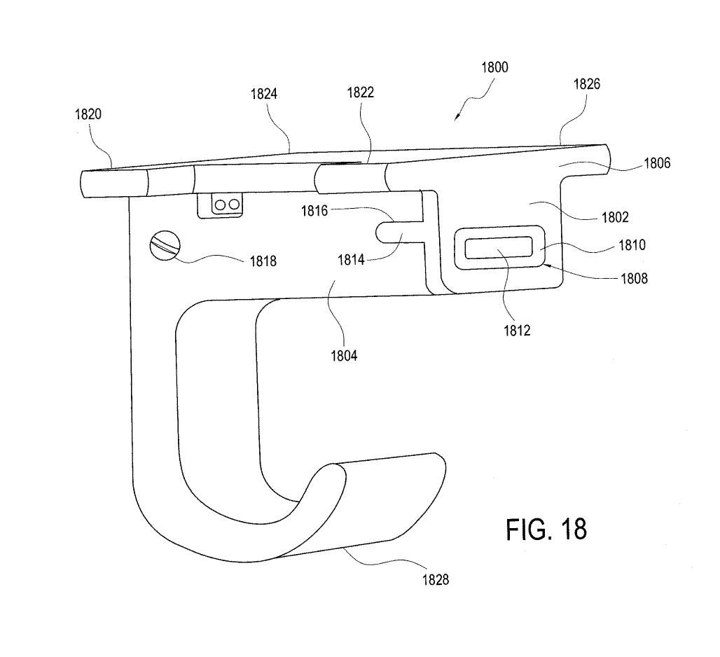

FIG. 18 shows, in schematic perspective view, a localized outlet 1800 that includes an assembly of components similar to service module 1600 and cover module 1700 as described above. Accordingly, the localized outlet 1800 includes a service module 1802 and a cover module 1804. As illustrated, a front surface region 1806 of the service module 1802 includes an aperture 1808 through which an illuminated bezel 1810 is visible, and through which a charging receptacle 1812 is accessible. A structural protrusion 1814 of the service module 1802 is disposed within, and supports, surfaces of a slot 1816 of the cover module 1804.

Respective portions of a fastener such as the illustrated machine screw 1818 are disposed within corresponding through holes of the service module 1802 and cover module 1804. The machine screw 1818 is threaded into internal threads of the service module through hole, so as to retain the cover module 1804 substantially permanently coupled to the service module 1802.

When in use, fastener such as screws are disposed through respective through holes of mounting lugs 1820, 1822, 1824, 1826 of the service module 1802, and into an adjoining supporting element in the environment. In light of the illustrated coupling between the cover module 1804 and the service module 1802 one of skill in the art will understand that the weight of an article suspended from hook portion 1828 of cover portion 1804 will be conveyed by the cover portion 1804, through the protrusions, e.g., 1814 and the machine screws, e.g., 1818 to the service module 1802, and from there through the mounting lugs 1820, 1822, 1824, 1826 of the service module 1802 to the supporting member in the environment. Consequently, the hook 1828 will provide substantial support for a personal article such as, e.g., a pocketbook, computer case or backpack.

As noted above, a single local outlet device may be configured to include multiple convenience features (such as pocketbook hooks) and/or multiple charging receptacles of various types and configurations at a single user location. The present disclosure is intended to include an apparatus in which multiple hooks and receptacles are incorporated into a single member which extends across multiple user locations.

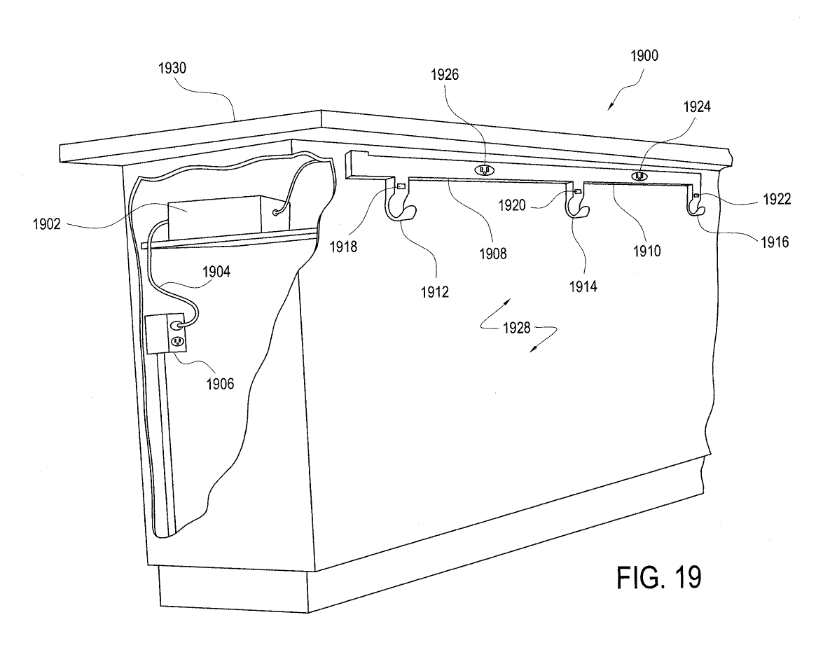

FIG. 19 shows, in schematic perspective view, a charging module and system 1900 prepared according to principles of the invention. The charging system 1900 includes a power supply 1902 electrically coupled at an input thereof by wiring 1904 to a mains supply 1906. The power supply 1902 is electrically coupled at an output thereof to a localized output module 1908. The localized output module 1908 includes a longitudinal member portion 1910 to which are coupled, or into which are integrated, a plurality of convenience features such as, e.g., pocketbook hooks 1912, 1914, 1916. Also incorporated into the localized output module 1908 are a plurality of electrical charging receptacles, e.g. 1918, 1920, 1922, 1924, 1926. Certain of these electrical charging receptacles may be low-voltage charging receptacle such as, e.g., USB charging receptacles. In the illustrated example, charging receptacles 1918, 1920 and 1922 are shown as USB charging receptacles.

In various embodiments of the invention, certain of the electrical charging receptacles may be high-voltage (e.g., mains voltage) charging receptacles. In the illustrated example, charging receptacles 1924 and 1926 are shown as high-voltage charging receptacles.

When in use, and as will be clear from the foregoing disclosure taken in its entirety, the localized outlet module 1908 will be supported by any appropriate or convenient surface in the environment such as, for example, the illustrated front surface region 1928 of a service bar 1930.

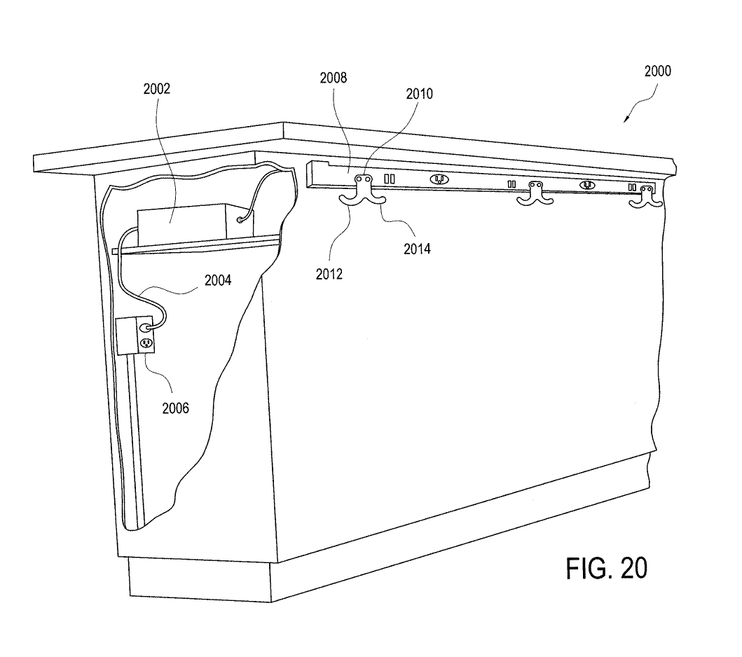

FIG. 20 shows, in cutaway schematic perspective view, a further embodiment of a charging module and system 2000 prepared according to principles of the invention. Like system 1900, system 2000 includes a power supply 2002 electrically coupled at an input thereof by wiring 2004 to a mains supply 2006. The power supply 2002 is electrically coupled at an output thereof to a localized output module 2008. The localized output module 2008 includes a convenience feature such as, e.g., a dual coat hook 2010. One of skill in the art will appreciate that such a dual coat hook will offer the advantage of allowing a user, such as a bar patron, to simultaneously and conveniently hang two separate articles adjacent to a seat or barstool while desirably charging a personal electronic device. For example, a user will, in certain instances, hang a jacket and a purse on the complementary sides of a dual hook. In other instances, a user will hang a wrap and a handbag on first 2012 and second sides 2014 of the hook respectively.

In various embodiments of the invention, certain of the electrical charging receptacles may be high-voltage (e.g., mains voltage) charging receptacles. In the illustrated example, charging receptacles 2024 and 2026 are shown as high-voltage charging receptacles.

When in use, and as will be clear from the foregoing disclosure taken in its entirety, the localized outlet module 2008 will be supported by any appropriate or convenient surface in the environment such as, for example, the illustrated front surface region 2028 of a service bar 2030.

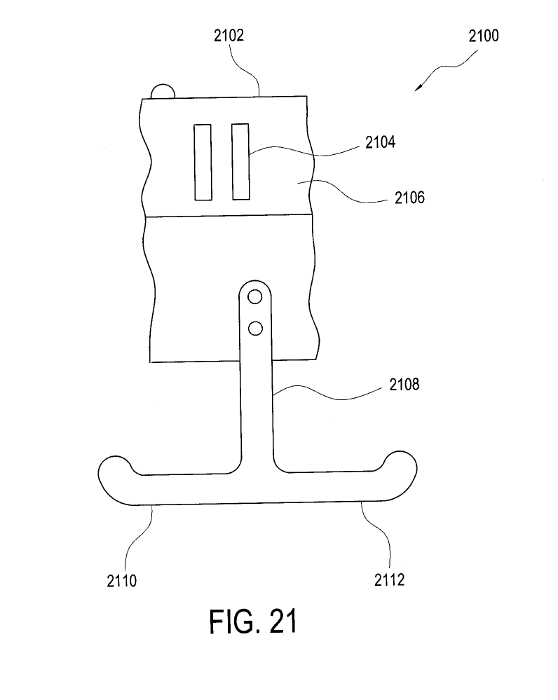

FIG. 21 shows, in schematic view, a portion of a charging system 2100, prepared according to principles of the invention, in additional detail. Specifically, charging system 2100 includes a charging module 2102 having a charging receptacle such as, for example, a USB charging receptacle 2104 within a body member 2106. Disposed below the USB charging receptacle 2104 and coupled to the body member 2106 is a dual coat hook 2108. The dual coat hook 2108 includes a first hook portion 2110 and a second hook portion 2112 disposed in mirror symmetry with respect to one another. In certain embodiments of the invention, an LED is coupled to the body member 2106 to assist a user in locating the apparatus.

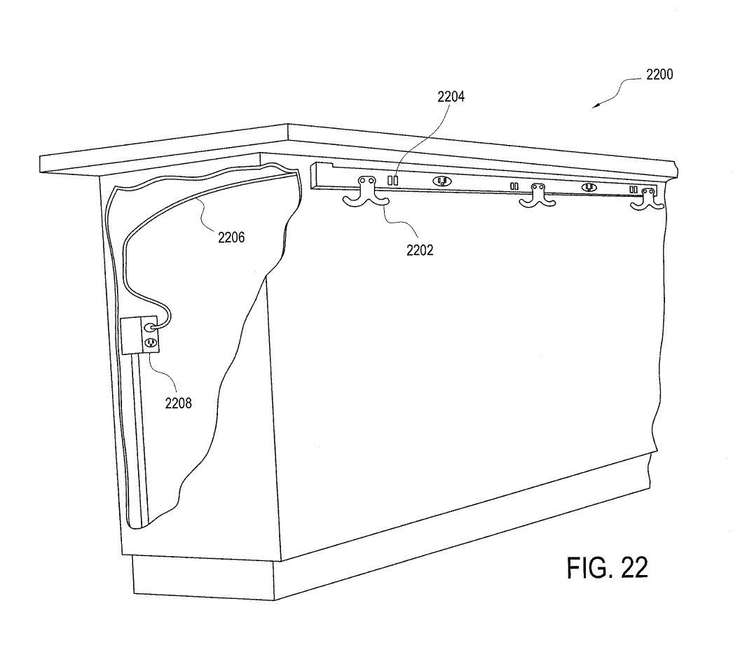

FIG. 22 shows, in cutaway schematic perspective view, a further embodiment of a charging module and system 2200, prepared according to principles of the invention. Like system 2000, system 2200 includes dual hooks, e.g., 2202 and USB receptacles, e.g., 2204. Charging module 2200 differs from charging module 2000, however, in that module 2200 is coupled by a power cord 2206 directly to mains power 2208, and voltage conversion from mains voltage to USB voltage takes place directly within the charging module.

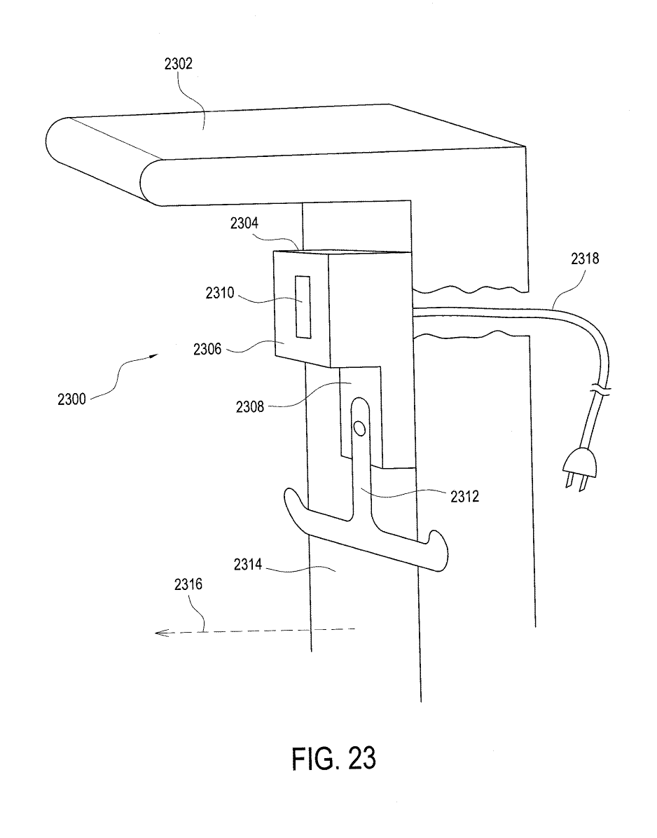

FIG. 23 shows, in schematic perspective view, a charging module 2300 as mounted and applied in the context of a service bar 2302. The charging module 2300 includes a body member 2304 including a first front surface region 2306 and a second front surface region 2308.

The first front surface region 2306 includes an aperture 2310 within which is disposed a USB charging receptacle. The second front surface region 2308 is coupled to and supports a dual coat hook 2312. The charging module 2300 is coupled to and supported by a generally vertical surface region 2314 of a pedestal of the service bar 2302.

Surface region 2306 is generally distal of the vertical surface region 2314 as compared with surface region 2308 which is generally proximal to the vertical surface region 2314. Consequently, the aperture 2310 of the USB receptacle is disposed away 2316 from vertical surface region 2314 as compared with dual hook 2312, thereby providing easy access to the USB receptacle for a user, notwithstanding the presence of a coat, a pocketbook, or other article hanging on one or both sides of the dual hook 2312.

The charging module 2300 is directly coupled to a mains power input cord 2318 and conversion from mains voltage to USB output voltage takes place within the body member 2304 of the charging module 2300. The mains power input cord 2318 will be of any appropriate length for ready coupling to a mains power supply. In certain embodiments, a 3 foot power cord will be supplied. In other embodiments of the invention, respectively, a 4 foot power cord and 8 foot power cord will be provided. One of skill in the art will appreciate that these lengths are merely exemplary, and that any appropriate power cord length will be provided according to the requirements of a particular application. In certain embodiments of the invention, ground fault circuit interruption will be provided integral to the mains power cord.

In certain embodiments of the invention, the convenience feature will include a security feature. Thus, for example, in certain embodiments of the invention, where the convenience feature is a hook, the hook will include a clasp or latch that will be locked mechanically or electronically by a user. This will tend to reduce the risk that a personal article suspended from the hook will be absconded with.

Likewise, in certain embodiments of the invention, an electronic alarm feature will be provided that notifies a user when a personal electronic device being charged at a localized outlet is disconnected from that outlet without the entry of a password or other (e.g., biometric) securing input. In certain embodiments, this functionality will be provided by hardware and/or software within the charging system or by an app or other software within the personal electronic device being charged or by a combination of both.

One of skill in the art will appreciate that the USB receptacle presented in relation to various localized outlets for purposes of the present disclosure is merely exemplary of a wide variety of functional couplings that will be employed in respective embodiments of the invention. Thus, for example, any appropriate wired and/or wireless charging mechanism (presently known or that becomes known to one of skill in the art) is intended to fall within the scope of the present disclosure. Accordingly, in respective embodiments, a localized outlet will include one or more of a USB outlet, a miniature USB outlet, an inductive or other electromagnetic wireless charging system, an optical or other wireless charging system, or any other system compatible with personal devices and other portable equipment in the future.

While the exemplary embodiments described above have been chosen primarily from the field of convenience chargers and charging systems for commercial establishments, one of skill in the art will appreciate that the principles of the invention are equally well applied, and that the benefits of the present invention are equally well realized, in a wide variety of other circumstances and environments including, for example, those found in home, automotive and public spaces. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but should occupy the full scope of the appended claims, and such other claims as may be properly presented in the future.

1. A method of charging a personal digital assistant device comprising:
placing said personal digital assistant within a carrier, said carrier including a first portion, said first portion defining a recess adapted to receive said personal digital assistant device and a second portion, said second portion defining an aperture;
disposing a portion of a coupling feature of a support device within said aperture so as to support said carrier with said support device; and
energetically coupling said personal digital assistant to a charging feature of said support device whereby an energy storage device of said personal digital assistant acquires an energy charge.

2. A method of charging a personal digital assistant device as defined in claim 1, wherein said support device is located below a beverage service bar.

3. A method of charging a personal digital assistant device as defined in claim 1 wherein said support device is located below a food service table.

4. A method of charging a personal digital assistant device as defined in claim 1 wherein said support device is located in a coat room.

5. A method of charging a personal digital assistant device as defined in claim 1 wherein said support device is coupled to a coat rack.

6. A method of charging a personal digital assistant device as defined claim 5 wherein said coat rack is coupled to a restaurant booth.

7. A method of charging a personal digital assistant device as defined in claim 1 wherein said charging feature further includes an anti-theft alarm feature, said method further including activating said alarm feature and, later in time, deactivating alarm feature prior to removal of said carrier by an authorized person.

8. A method of charging a personal digital assistant device as defined in claim 1 wherein said energetically coupling said personal digital assistant device to said charging feature comprises a wired coupling.

9. A method of charging a personal digital assistant device as defined in claim 1 wherein said energetically coupling said personal digital assistant device to said charging feature comprises a wireless coupling.

10. A method of charging a personal digital assistant device as defined in claim 9 wherein said wireless coupling comprises a near field electromagnetic induction coupling.

11. A method of charging a personal digital assistant device as defined in claim 1 further comprising:
providing a lamp and illuminating said aperture with said lamp to facilitate disposing said portion of said support device therein.

12. A charging station comprising:
a body, said body being shaped to couple readily to a portion of a service bar so as to support said body beneath a service portion of said service bar;
a hook, said hook being configured to support an electronic communication device;
a power supply, said power supply being coupled to said body, said power supply configured to receive mains power and to provide a charging current to said electronic communication device; and
a light, said light being coupled to said body, said light being positioned to facilitate a temporary coupling of said electronic communication device to said hook.

13. A charging station as defined in claim 12 further comprising:
an alarm circuit, said alarm circuit including an annunciator, said alarm circuit being configured to activate said annunciator in the event of an unauthorized removal of said electronic communication device from said hook.

14. A charging system for a personal electronic device comprising:
a power supply;
a plurality of charging modules, said plurality of charging modules being electrically coupled to said power supply; and
an electrical conductor disposed between at least a first charging module and a second charging module of said plurality of charging modules, wherein at least one of said charging modules includes a coupling feature, said coupling feature being configured to support a personal article and wherein said charging module includes a receptacle, said receptacle being electrically coupled to said power supply and configured to receive a charging connector for a personal electronic device.

15. A charging system as defined in claim 14 wherein said coupling feature comprises a hook.

16. A charging system as defined in claim 14 wherein said coupling feature configured to support a personal article comprises a coupling feature configured to support a pocketbook.

17. A charging system as defined in claim 14 wherein said coupling feature configured to support a personal article comprises a coupling feature configured to support a jacket.

18. A charging system as defined in claim 14 wherein said charging connector for a personal electronic device comprises a charging connector for a smart phone.

19. A charging system as defined in claim 14 wherein said charging connector for a personal electronic device comprises a charging connector for a computer tablet.

20. A charging system as defined in claim 14 wherein said charging connector for a personal electronic device comprises a charging connector for a laptop computer.
